(19) United States
(12) Patent Application Publication
(10) Pub. No.: US 2005/0255367 A1
(43) Pub. Date: Nov. 17, 2005

(54) Fuel cell, separator unit kit for fuel cell, and fuel cell generating unit kit

(76) Inventors: Ko Takahashi, Hitachi (JP); Hiroshi Yamauchi, Hitachi (JP); Kenji Yamaga, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/059,361

(22) Filed: Feb. 17, 2005

(30) Foreign Application Priority Data
May 13, 2004 (JP) 2004-143293

(51) Int. Cl. H01M 8/02; H01M 8/10; H01M 4/94; H01M 8/04

(52) U.S. Cl. 429/38; 429/32; 429/44; 429/26

(57) ABSTRACT

A fuel cell includes multiple generating units layered in multiple, each unit including an electrolyte membrane electrode assembly, gas diffusion layers placed to sandwich the assembly, and a pair of separator units placed outside the gas diffusion layers, wherein a flow channel space is formed between the separator units and the gas diffusion layers, each of the separator units has a separator substrate with multiple gas flow channel grooves, and a pair of frames placed on both surfaces of the substrate, and the cross-sectional area of the flow channel in a direction orthogonal to the direction of the flow channel grooves is different in an upstream portion and a downstream portion. The present invention also discloses a fuel cell separator unit kit and a fuel cell generating unit kit.

### BACKGROUND OF THE INVENTION

1. Field of the Invention

The present invention relates to a fuel cell, a separator unit kit for a fuel cell and a fuel cell generating unit kit, and in particular to flow channel structure of a fuel cell separator unit.

2. Description of the Prior Art

In a polymer electrolyte fuel cell, an electrolyte membrane electrode assembly (hereafter referred to as a membrane electrode assembly) in which both sides of a polymer electrolyte membrane are coated with electrode catalysts consisting of an anode and a cathode is inserted between gas diffusion layers and further, separators for supplying a fuel gas and an oxidizer gas are placed on both sides of the membrane electrode assembly to constitute a unit cell (a generating unit). A layered body is formed by placing the plurality of unit cells, and both ends of the layered body are fastened with fastening plates so as to constitute a fuel cell stack. This fuel cell stack is laminated and installed so that an in-plane direction of a membrane electrode complex is perpendicular to a horizontal direction.

A reaction formula of the polymer electrolyte fuel cell is shown below.
Anode: H₂→2H⁺+2e⁻
Cathode: 2H⁺+2e⁻+½O₂→H₂O
Entirety: H₂+½O₂→H₂O

In the polymer electrolyte fuel cell, hydrogen (H₂) included in a fuel gas which has diffused in the gas diffusion layers emits electrons (e⁻) and becomes proton (H⁺) when reaching the anode. The proton (H⁺) moves from an anode side to a cathode side through the polymer electrolyte membrane. However, since the electrons (e⁻) cannot move from the anode side to the cathode side, those move to the cathode side by way of an external circuit.

On the other hand, on the cathode side, the proton (H⁺) having moved through the above mentioned polymer electrolyte membrane, the electrons (e⁻) sent from the external circuit, and oxygen in an oxidizer gas (air) react to generate water (H₂O). A major part of the generated water evaporates in an unreacted gas, and is discharged to the outside of the cell stack as it is. However, in an oversaturated state, it will stay behind.

In the case of the polymer electrolyte fuel cell, when generating electric power, it is necessary not only to supply the fuel gas and oxidizer gas as reactive gases to the anodes and the cathodes respectively, but also to supply moisture to a solid polymer membrane. This is because conductivity of the proton (H⁺) for moving from the anode side to the cathode side through the solid polymer membrane is considerably improved by sufficiently supplying the moisture to the solid polymer membrane. In order to supply the moisture to the solid polymer membrane, steam (H₂O) is added to the reactive gas to supply the water to the fuel cell.

When the hydrogen (H₂) in the fuel gas and the oxygen (O₂) in the oxidizer gas are consumed by a cell reaction, the steam added and supplied to the fuel gas and the oxidizer gas for humidifying the polymer electrolyte membrane will exist as liquid in a reactive gas flow channel as condensed water if an unreacted emission gas becomes oversaturated. The water is apt to stay inside the flow channel for flowing the fuel gas and the oxidizer gas of a separator unit. If the water is not removed, it becomes an obstacle to diffusion of the fuel gas and the oxidizer gas, so that the cell reaction is considerably deteriorated and cell performance is lowered.

It is thinkable to pass a gas at a certain flow rate or faster required to discharge the liquid staying in the flow channel along a cell stack flow channel. In the case of the fuel cell reaction, since the reactive gas is consumed by the reaction as it proceeds from an upstream side to a downstream side thereof, the reactive gas flow rate in the flow channel becomes slow, so that relative humidity in the flow channel rises to cause the environment where oversaturation and condensation easily occur. Therefore, it is desirable that the flow rate in the most downstream portion of the reactive gas flow channel, that is, in the proximity of an outlet of a cell flow channel is equal to or higher than that a flow rate necessary to discharge the condensed water. However, if the cross-sectional area of the flow channel is decided according to a flow rate in the proximity of the outlet, the flow rate becomes higher in the proximity of an inlet on the upstream side. In view of this, JP-A-2003-132911 discloses a fuel cell flow channel structure which changes the depth of a groove of a reactive gas flow channel in a cell in-plane direction, for example.

Further, JP-A-2003-92121 discloses a fuel cell flow channel structure which changes the cross-sectional area of a flow channel in a flow direction while a flow direction of a fuel gas is opposed to that of an oxidizer gas.

Further, JP-A-2000-223137 discloses a fuel cell flow channel structure which reduces the width of a rib contact projection or a flow channel in a flow direction of a reactive gas.

### BRIEF SUMMARY OF THE INVENTION

The fuel cell flow channel structures disclosed in JP-A-2003-132911 and JP-A-2003-92121 are limited to the cases where the flow direction of a fuel gas flow channel and the flow direction of a flow channel of an oxidizer gas flowing on a backside of the fuel gas flow channel are opposed to each other. Also, in the flow channel structure of the fuel cell disclosed in JP-A-2000-223137 has a problem that it is not possible to independently set up how to change cross-sectional areas of the flow channels on front and rear surfaces of a separator substrate.

In order to prevent cell performance from deteriorating, there is a need for a separator unit capable of efficiently discharging generated water or condensed water produced by a cell reaction from a reactive gas flow channel, and preventing retention of air bubbles if a coolant flowing in a cooling unit is made of liquid.

An object of the present invention is to provide a separator unit which can be manufactured simply and inexpensively on basis of the above described foundation.

According to the present invention, there is provided a fuel cell configured so that a generating unit includes a membrane electrode assembly, gas diffusion layers placed to sandwich the membrane electrode assembly therebetween, and a pair of separator units placed outside the gas diffusion layers, and the plurality of generating units are laminated, wherein the cross-sectional area of a flow channel of a flow channel space formed between the separator unit and the gas diffusion layer is smaller in a downstream portion than in an upstream portion of fluid. The separator unit may be configured by a separator unit for gas supply and at least one separator unit for supplying a coolant.

Also, according to the present invention, there is provided a fuel cell separator kit including a separator substrate having multiple flow channel grooves, and frames provided on both sides thereof, wherein a member for changing the cross-sectional area of the flow channel in a flow direction is formed in the frames. Further, there is provided a fuel cell generating unit kit including a membrane electrode assembly, gas diffusion layers placed on both sides thereof, and separator kits placed outside the gas diffusion layers.

According to the present invention, it is possible that a separator substrate has substantially the same shape on front and rear surfaces thereof. Therefore, the separator unit may be manufactured easily and inexpensively. Further, since it is possible to create an arbitrary flow channel configuration, retention water can be discharged efficiently.

A configuration of a fuel cell according to the present invention will be concretely described below. First, in a fuel cell stack formed by placing lamination multiple unit cells configured by placing separator units sandwiching on both sides of a membrane electrode complex to sandwich it, the separator units take one of the following combinations of flow channel grooves.

(1) A fuel gas flow channel formed on one surface of the separator unit, and an oxidizer gas flow channel formed on the other surface.

(2) A fuel gas flow channel formed on one surface of the separator unit, and a cooling unit flow channel formed on the other surface.

(3) An oxidizer gas flow channel formed on one surface of the separator unit, and a cooling unit flow channel formed on the other surface.

A member is provided for preventing a reactive gas from moving to an adjacent flow channel groove formed between a frame and a separator substrate on each surface, for example, for rendering the cross-sectional area orthogonal to a flow direction of the gas flow channel smaller in a downstream portion or at an outlet than in an upstream portion or at an inlet of a gas flow, that is, for rendering a flow rate of the gas in the downstream portion higher, by means of projections independently on front and rear surfaces. Also, there is provided a member for changing a gas flow direction, on the other frame. However, regarding an oxidizer gas flow channel groove of the separator unit, it is possible to omit the member for changing the cross-sectional area of the flow channel or to reduce the number thereof because an absolute amount of oxidizer consumed in the fuel cell is smaller than that of a fuel gas and so there is no extreme change of the gas flow between the upstream portion and the downstream portion thereof. As opposed to this, in the case of the fuel gas, an absolute amount of fuel consumed in the fuel cell is large and so there is a significant change of gas volume between the upstream portion and the downstream portion thereof. Accordingly, the member is essential for the fuel gas. The separator unit is configured by placing the frames, constituted in the above way, on both sides of the separator substrate.

The frame has a window at the center thereof, and a return structure in its peripheral part (frame) on a side contacting the separator substrate for forming a fluid flow in a lateral direction. Further, in the frame, a gas inlet manifold, and a gas outlet manifold and/or a coolant inlet manifold, and a coolant outlet manifold of the same structure as the separator substrate are formed. A surface of the frame contacting a gas diffusion layer is smooth, and has a seal structure with respect to the gas diffusion layer and an electrolyte membrane. In the window, a member of a portion for virtually dividing the multiple flow channel grooves into a desired number of multiple flow channel groove groups is formed. The number of the flow channel groove groups in the downstream portion is made smaller than that in the upstream portion so as to increase a flow rate of the gas (fuel gas and oxidizer gas) in the downstream portion. The separator substrate and the frame constituting a separator are made from a corrosion-resistant material respectively, for example, from a stainless steel plate by means of press molding.

It is thereby possible to provide the fuel cell capable of changing the cross-sectional area of the flow channel in the flow direction while maintaining the width and a pitch of a flow channel groove of the separator substrate. Consequently, it is possible to effectively discharge generated water or condensed water produced by a cell reaction even if it is stayed behind in a reactive gas flow channel in the separator substrate. Therefore, it is possible to effectively supply the fuel gas and the oxidizer gas to the reactive gas flow channel so as to provide the fuel cell capable of further improving cell performance.

In other words, according to the fuel cell of the present invention, it is possible to configure the flow channel in a desired form on the front and rear surfaces of one separator substrate without changing or increasing the form or kind of flow channel grooves of the separator substrate. Further, it is possible to secure a desired flow rate in the upstream and downstream portions of the flow channel grooves by adequately placing the members formed on the frame. The flow rate at a cell inlet part does not become excessive and further, the desired flow rate at a cell outlet part can be secured, so that a characteristic that the generated water or condensed water produced in the flow channel can be effectively discharged is achieved.

In one concrete embodiment of the present invention, it is desirable that: the separator unit have the separator substrate having multiple flow channel grooves and a pair of frames placed on both sides thereof; a member for dividing those into an arbitrary number of flow channel groove groups and changing the cross-sectional area of the flow channel provided on the window on the side on which the frames face the gas diffusion layers is provided; and a return structure for changing the flow of the fluid into a lateral direction with respect to the direction of the flow channel grooves is provided on the side on which the frames contact the separator substrate.

One end of the return structure is communicated with a fluid inlet manifold, and the other end is communicated with a fluid outlet manifold. There is provided the fuel cell in which multiple generating units are layered, each of the generating units including a membrane electrode assembly, gas diffusion layers placed to sandwich the assembly, and a pair of separator units placed outside the gas diffusion layers, a flow channel space being formed between the separator units and the gas diffusion layers, and each of the separator units has the separator substrate having multiple flow channel grooves and a pair of frames provided on both sides thereof, and the members for changing the cross-sectional area of the flow channel between the upstream portion and the downstream portion being provided in the frames.

One surface (on the side contacting the separator substrate) of the frame has a flow channel groove portion for changing the flow direction of the fluid formed thereon, and the other surface (on the side contacting the gas diffusion layer) has the member for preventing the reactive gas from moving to an adjacent flow channel groove provided thereon. Consequently, the fuel cell of which cross-sectional area of the flow channel of the reactive gas flow channel groove is different between the upstream portion and the downstream portion is provided. For instance, the cross-sectional area of the flow channel of a fluid outlet is made smaller than that of a fluid inlet, and a fluid flow rate at the outlet is made higher so as to efficiently discharge the water accumulated in the separator unit.

Positions and shapes of the members are adjusted so that the cross-sectional area of the flow channel in the downstream portion of the gas or the liquid in the generating units becomes smaller than that in the upstream portion. Also, by the flow channel groove portions or members provided to the frames, it becomes possible to change the number of reactive gas flow channels running in parallel with the inlet portion and outlet portion of the cell. Then, it is also possible to make the pitch of the projections positioned inside the space (the flow channel space) configured by the frames and the separator substrates smaller as it goes downstream.

It is also possible to make the pitch of a flow channel inlet portion opened on a manifold of the surface of the frame contacting the separator substrate equal to the pitch of the flow channel groove portion provided on the separator substrate. It is also possible to form the projections provided on the window of the frame over the entire length of the space of the frame (over the entire length of the window). Then, it is preferable to form the separator substrate by machining or press-working a metal plate, in many respects such as cost, handling and dimensional accuracy.

Another embodiment of the present invention provides the fuel cell wherein it has multiple generating unit cells configured by placing the separator units to sandwich the membrane electrode assembly on both sides thereof, in which a layered body is formed by placing one cooling unit placed for one or more generating units by means of lamination, a coolant flow channel of the unit cells being formed by providing one separator substrate on which the flow channel for communicating the reactive gas or the coolant is formed on both the front and rear surfaces and the frames forming a seal portion, the fuel cell being provided with the cooling unit which changes the flow direction of the coolant by means of a guide portion provided on the frame forming the seal portion.

It is possible to independently set locations of the projections provided on the frames for preventing the reactive gas from moving to an adjacent flow channel groove unit on the frames positioned on the front and rear surfaces of the separator substrate, respectively. It is also possible to independently form the projections provided on the frames for preventing the reactive gas from moving to the adjacent flow channel groove unit, and the guide portions provided on the frames for changing the flow direction of the coolant on the frames, by means of the frames positioned on the front and rear surfaces of the separator substrate respectively.

The present invention provides a fuel cell separator unit kit having a separator substrate with multiple flow channel grooves on both surfaces, and a frame contacting both surfaces of the separator substrate for forming a space through which fluid flows, where at least one of the frames has one or more members for changing the cross-sectional area in a direction orthogonal to the flow direction of the flow channel. As a matter of course, this kit may include other components, such as a membrane electrode assembly and a water-cooled separator unit for instance. The water-cooled separator unit may be configured as proposed by the present invention, that is, may be constituted by a separator substrate and a pair of frames, or may have a conventional water-cooled structure.

The present invention further provides a fuel cell generating unit kit having a membrane electrode assembly including an electrolyte membrane and electrodes contacting both surfaces thereof, gas diffusion layers placed on both faces of the membrane electrode assembly, and a pair of separator units placed outside the gas diffusion layers, wherein the separator unit has a separator substrate with multiple flow channel grooves on both surfaces thereof, and frames contacting both faces thereof for forming a space in which fluid flows, and at least one of the frames has one or more members for changing the cross-sectional area of the flow channel in a direction orthogonal to the flow direction. As a matter of course, this kit may include all or a part of the components necessary to configure a generating unit or a fuel cell stack, such as a water-cooled separator unit and an end plate.

The separator unit has a common fluid inlet manifold and a fluid outlet manifold, which are layered. The members are formed in a space portion of the pair of frames in a direction parallel to the flow channel grooves. The members may be formed on one of the pair of the frames in a direction parallel to the direction of the flow channel grooves along with a member for forming the flow of the fluid in a lateral direction to the direction of the flow channel grooves.

It is desirable that the fluid of the generating unit includes a fuel gas or an oxidizer gas, and water as coolant, and that a fluid speed in the downstream portion is higher than that in the upstream portion. It is desirable that the members change the flow direction of the fluid on the upstream side of the flow channel grooves and the flow direction of the fluid on the downstream side, once at least. It is desirable that the members is formed at a position at which the number of the flow channel grooves is different between the inlet portion and the outlet portion of the separator unit.

It is desirable that the closer to fluid outlet manifold, the smaller the pitch of the members is to make the fluid flow rate higher. It is also possible to adjust the pitch of the flow channel inlet portion opened on the manifold on the surface contacting the separator substrate of the frame to the pitch of the flow channel groove portion provided on the separator substrate. It is also possible to form the members provided on the frames, over the entire window (space) of the frame. It is possible to make the length of the flow channel groove in the window substantially equal to the dimension of the window.

The flow channel groove of the separator substrate can be formed by machining or pressing the metal plate. According to the present invention, the shape and number of the flow channel grooves can be the same on both surfaces of the separator substrate so that the machining is made very easy and with low-cost.

Hereunder, the embodiments of the fuel cell according to the present invention will be described by taking a polymer electrolyte fuel cell for example and using the drawings.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1A is a perspective view showing a structure of a separator unit of a fuel cell according to a first embodiment of the present invention;

FIG. 1B is a sectional view along line A-A′ in FIG. 1A;

FIG. 2 is an exploded perspective view showing a configuration of a main portion of a fuel cell stack according to the embodiment of the present invention;

FIG. 3 is a perspective view showing a structure of a first frame on a side contacting a separator substrate, according to the first embodiment of the present invention;

FIG. 4 is a perspective view showing a structure of the frame on a side contacting a gas diffusion layer, according to the first embodiment of the present invention;

FIG. 5 is a perspective view showing a structure of the frame on the side contacting the separator substrate, according to a second embodiment of the present invention;

FIG. 6 is a perspective view showing a structure of the frame on the side contacting the gas diffusion layer, according to the second embodiment of the present invention;

FIG. 7 is a perspective view showing a structure of the frame on the side contacting the separator substrate, according to a third embodiment of the present invention;

FIG. 8 is a perspective view showing a structure of the frame on the side contacting the separator substrate, according to a fourth embodiment of the present invention;

FIG. 9 is a perspective view showing a structure of the frame on the side contacting the separator substrate, according to a fifth embodiment of the present invention;

FIG. 10 is a perspective view showing a flow channel configuration portion of a cooling unit of the fuel cell according to a sixth embodiment of the present invention;

FIG. 11A is a plan schematic view showing a relation among a flow direction of fluid on the first frame side, the number of flow channel grooves, and locations of projections, in the separator substrate of the separator unit according to an embodiment of the present invention; and

FIG. 11B is a plan schematic view showing a relation among a flow direction of fluid on the second frame side, the number of flow channel grooves, and locations of projections, in the separator substrate of the separator unit according to the embodiment of the present invention.

### DETAILED DESCRIPTION OF THE INVENTION

### Embodiment 1

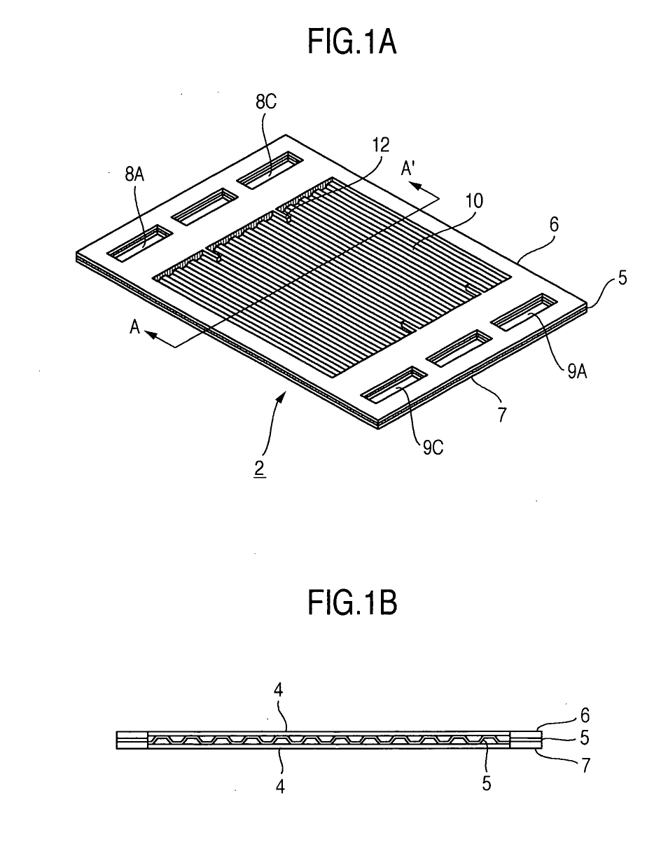

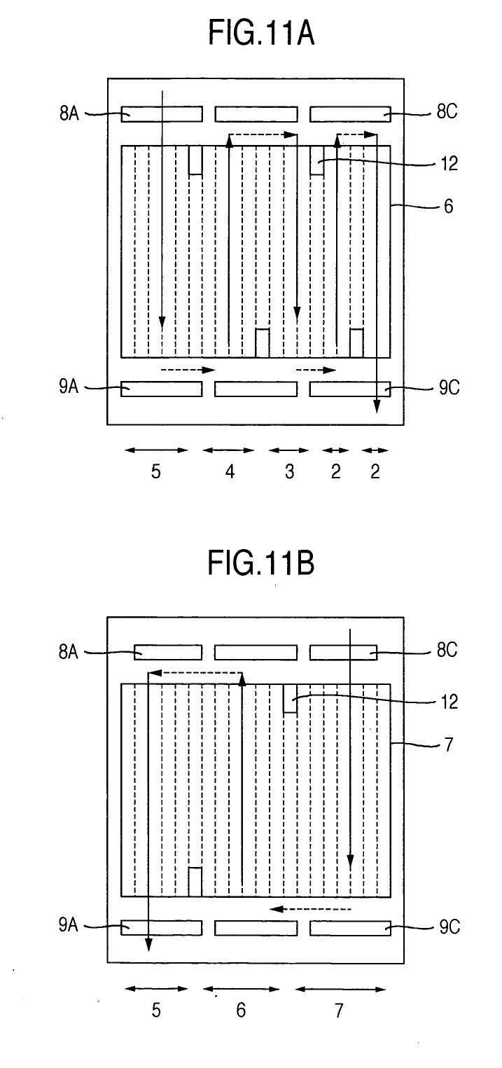

FIG. 1A is a perspective view showing a structure of a separator unit according to a first embodiment of a fuel cell of the present invention, and FIG. 1B is a sectional view along line A-A′ in FIG. 1A. As is clear in FIGS. 1A and 1B, the separator unit configuring the most important characterizing portion of the embodiments of the present invention has structure in which a separator substrate 5 having multiple parallel flow channel grooves 10 is sandwiched by two frames 6 and 7 (a first frame 6 and a second frame 7). The separator substrate 5 and the frames 6 and 7 have a common fuel gas inlet manifold 8A, a common oxidizer inlet manifold 8C, a common fuel gas outlet manifold 9A and a common oxidizer outlet manifold 9C, and are layered. The first frame 6 has a projection 12 provided thereon so that the cross-sectional area of the flow channels in the downstream portion becomes smaller than that in the upstream portion, that is, the number of the flow channel grooves in the downstream portion becomes smaller than that in the upstream portion, in other words. In FIG. 11, the first frame and the second frame have four projections 12 provided thereon, respectively. As previously mentioned, the number of the projections on the second frame side (oxidizer gas side) can be smaller than that on the first frame side (fuel gas side), and so some of the projections may be omitted for instance. Thus, the gas flow is changed by the projections, and the gas moves in the lateral direction due to the return structure provided on the frame and flows in an opposite direction. Likewise, the gas flow turns around, and the cross-sectional area of the flow channel decreases. Therefore, as it goes downstream, the flow rate becomes higher or equal to that in the upstream. Gas diffusion layers 4 are mounted on both sides of the separator unit.

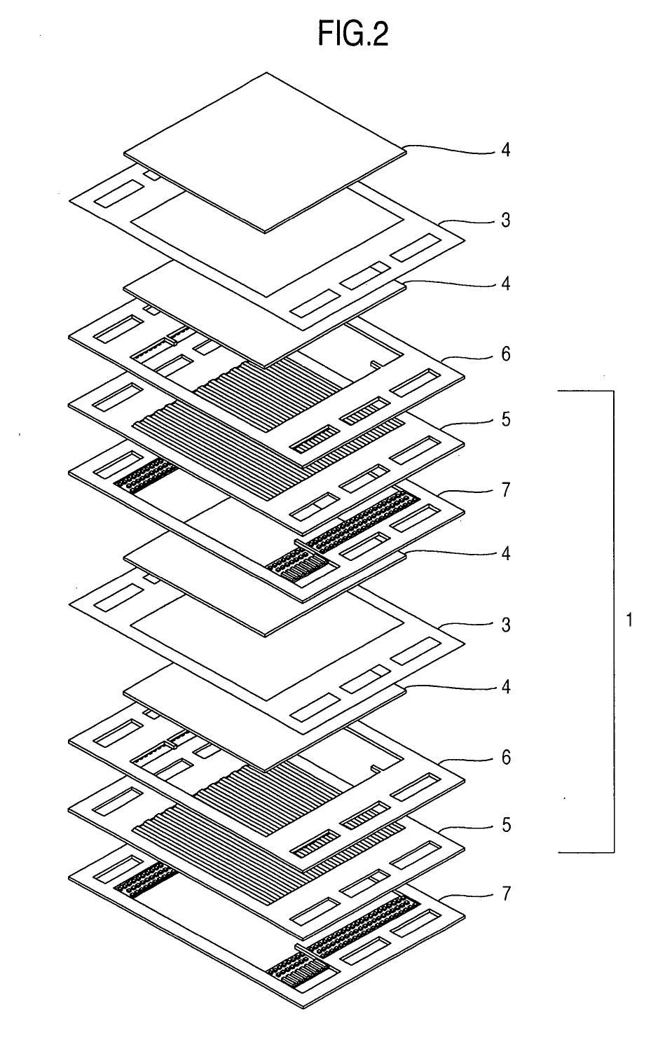

As shown in FIG. 2, the fuel-cell cell according to the present invention sandwiches a membrane electrode assembly 3, in which both sides of the a solid polymer electrolyte membrane are coated with electrode catalysts consisting of an anode and a cathode, from both sides thereof by the gas diffusion layers 4 and further, layers and places multiple unit cells 1 on both side thereof, each of which consists of the separator units for supplying the fuel gas and the oxidizer gas to form a fuel cell layered body (stack).

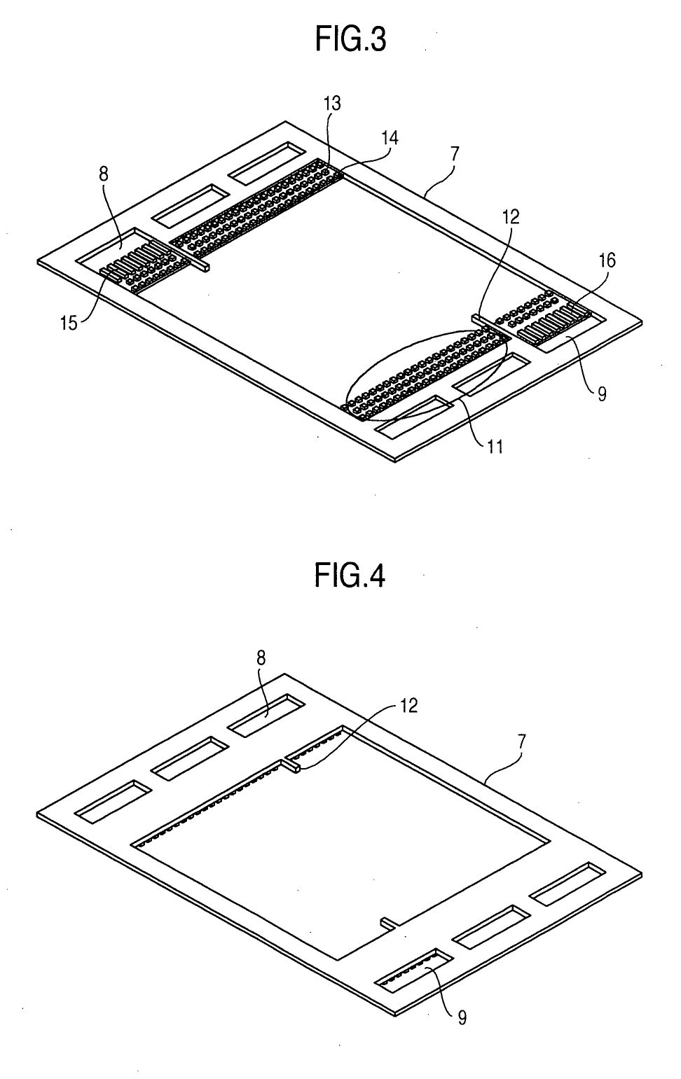

FIG. 3 is a diagram showing a structure on an opposite side to a side contacting the separator substrate, and shows a frame structure in the case of providing the projections 12 for preventing the reactive gas from moving to an adjacent flow channel groove at two locations, which is the first frame 6 shown in FIGS. 1 and 2. FIG. 3 is a view of the frame from the side contacting the surface of the separator substrate. In FIG. 3, the fuel gas supplied to the cell stack is supplied to the reactive gas flow channel grooves 10 of the separator substrate from the inlet manifold 8 by way of a flow channel inlet portion 15 on the inlet side. The fuel gas reverses the gas flow direction at a flow channel return portion 11 provided on the rear surface of a frame seal portion (shown in FIG. 3), and flows in the reactive gas flow channel grooves 10 of the separator substrate again in the direction opposite to that before the return. It reverses the gas flow direction at the flow channel return portion 11 again, passes the flow channel grooves 10 of the separator substrate, and is discharged to the outside of the cell from an outlet side flow channel discharge portion 16 so as to be discharged to the outside of the cell stack by way of the outlet manifold 9.

In the case that the flow channel of the flow channel return portion 11 is formed by parallel flow channel grooves, the projection 12 operates as a shield for preventing a bypass leak to the adjacent flow channel grooves. In the case that the flow channel of the flow channel return portion 11 is configured by projections 13 and 14, the projection 12 is provided at the return portion and becomes a boundary portion of the flow channel in which the gas of the flow channel grooves 10 of the separator substrate flows in parallel so that the number of the flow channels flowing in parallel can be arbitrarily set according to the mounting positions and the number thereof. The projection 12 is provided on the frame so that it exerts no influence over a backside of the surface of the separator substrate. For that reason, it is possible, just by using the frame of one kind of shape with respect to the flow channels provided on the front and rear surfaces of the separator substrate, to set the number of times of return and the number of the flow channels flowing in parallel independently on both surfaces, respectively.

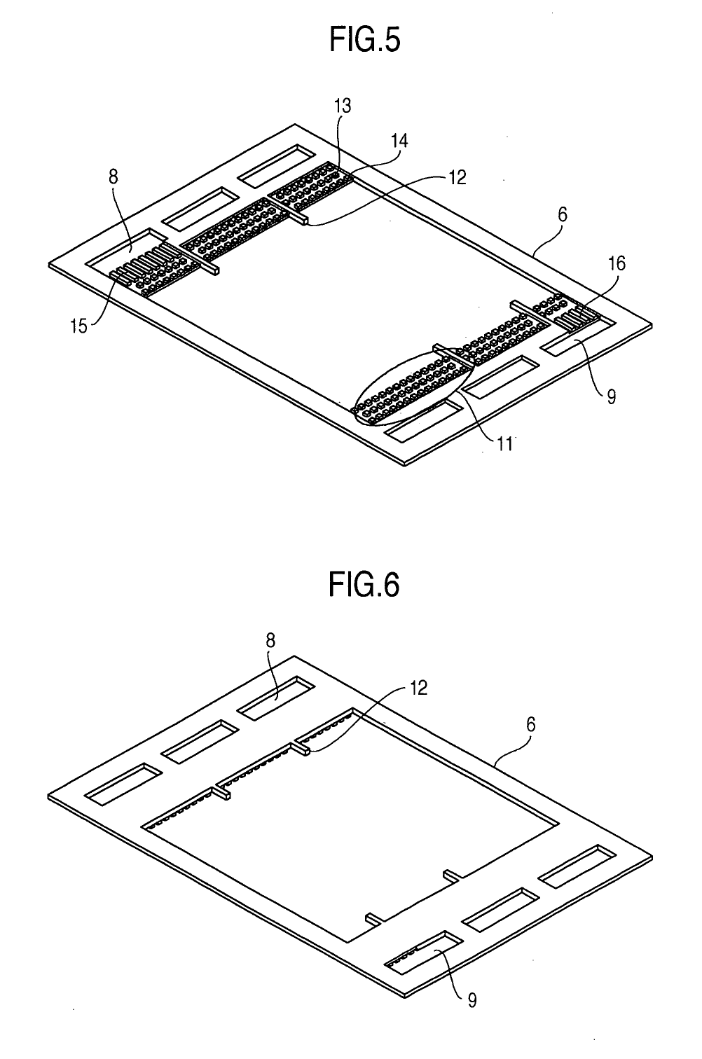

FIGS. 5 and 6 are diagrams showing the frame structure in the case of providing the projections for preventing the reactive gas from moving to the adjacent flow channel groove at four locations. FIG. 5 is a view from the side contacting the surface of the separator substrate of the frame. FIG. 6 is a view of the frame seen from the side contacting the surface of the electrolyte membrane via the gas diffusion layers, which is the view of FIG. 5 seen from the backside. In FIG. 5, the fuel gas supplied to the cell stack is supplied to the reactive gas flow channel grooves 10 of the separator substrate from the inlet manifold 8 by way of the flow channel inlet portion 15 on the inlet side. The fuel gas is reversed four times in total at the flow channel return portion 11 provided on the rear surface of the frame seal portion, and is discharged to the outside of the cell from the outlet side flow channel discharge portion 16 so as to be discharged to the outside of the cell stack by way of the outlet manifold 9.

FIGS. 11A and 11B are schematic views showing the fluid flow on the side (a) contacting the electrolyte membrane via the gas diffusion layers of the separator unit and the side (b) contacting the separator substrate of the embodiments according to the present invention. Both FIGS. 11A and 11B are plan views. As shown in these drawings, even if the structures of the flow channel grooves formed on the separator substrate are the same on both surfaces, it is possible to form a different structure of a flow channel section on the respective surfaces. Moreover, it can be implemented by a very easy method of just lapping the frame over the separator substrate to form a desired flow channel configuration. Typically, the fuel gas is supplied on side (a), and the oxidizer gas is supplied on side (b) so as to be supplied to a catalyst layer of the membrane electrode assembly via the gas diffusion layers contacting the separator unit. On side (a), the fuel gas enters from the fuel gas inlet manifold 8A and flows in the flow channel grooves 10 formed on the separator substrate so as to be discharged from the fuel gas outlet manifold 9C while being guided by the projections 12. It diffuses through five flow channel grooves in the proximity of the fuel gas inlet 8A. It is shifted to an adjacent flow channel group by a flow channel changing means formed on the frame before the manifold 9A. As shown in FIG. 11A, a first flow channel group has five flow channel grooves, and the number thereof becomes 4, 3, 2 and 1 as it goes downstream. The more downstream it goes, the higher the gas flow rate becomes.

FIG. 11B shows the gas flow on the side to which the oxidizer gas is supplied. As opposed to side (a), the oxidizer gas enters from the inlet manifold 8C on the right side of the separator unit, and is discharged from the oxidizer gas outlet manifold 9A at the lower left side. As is clear from comparison between FIGS. 11A and 11B, the flow channel grooves 10 formed on the separator substrate are the same on both surfaces, and those have the same shape on both surfaces. However, the numbers of flow channel groups formed by the projections are 7, 6 and 5 counted from the upstream side respectively, which do not change greatly in comparison with those on the first frame side. Therefore, manufacturing of the separator substrate is very easy, and its structure can be simplified so that it is inexpensive. It is possible to form an arbitrary flow channel groove configuration just by providing the members 12 for regulating the gas flow to the pair of frames (first frame 6 and second frame 7) to be superposed on the separator substrate or providing the members for changing the flow channel of the gas flow. Thus, the configuration of the separator unit is easy and inexpensive.

In the case that the number of the projections 12 is increased while keeping the number of the flow channel grooves on the separator substrate fixed, the number of times of return increases and the number of the flow channels flowing in parallel decreases. More specifically, it is possible to decrease the cross-sectional area of the flow channel. It is also possible to further decrease the number of the flow channels running in parallel by narrowing the distance of installation of the projections 12 as it goes from the inlet side to the outlet side instead of keeping it fixed so as to further decrease the cross-sectional area of the flow channel. FIG. 5 shows an example in which the number of the grooves of the outlet side flow channel discharge portion is made smaller than that of the flow channel inlet portion opened on the inlet manifold on the first frame 6 shown in FIGS. 1 and 2.

In the case of a fuel cell, there are the cases that, for the sake of increasing generating efficiency, it may be operated by setting a fuel utility factor indicating a ratio of a consumed fuel flow to a supplied fuel flow approximately at 80%. In comparison, there are many cases that it is operated at 40 to 60% or so of an oxidizer utility factor indicating a ratio of a consumed oxygen flow to an oxygen flow in a supplied oxidizer gas. For that reason, a fuel gas flow has a less supply gas flow and a higher utility factor than those of an oxidizer gas flow so that the fuel gas has apparently less gas flow discharged from the outlet side flow channel discharge portion 16 to the outlet manifold 9. More specifically, the flow rate is lower in the case of flowing in the flow channels having the same cross-sectional area of the flow channel. It is desirable to operate it on condition that the generated water and steam for humidification will not be condensed in the reactive gas flow channel. However, the condensed water may be locally generated because there occurs temperature distribution in the cell stack. To discharge the condensed water out of the cell, it is thinkable to discharge it together with the gas having the flow rate of a certain speed or higher.

For instance, in the case of supplying the fuel gas of hydrogen 100% and performing operation at a fuel utility factor of 80%, an outlet discharge gas flow is reduced to a fifth of a supply fuel gas flow. In the case of supplying the air of oxygen concentration of 21% as an oxidizer gas and performing operation at an oxidizer gas utility factor of 50%, the flow just decreases in the order of 10% or so. This indicates that the flow rate of the oxidizer gas just changes by 10% or so even at the inlet and outlet, while that of the fuel gas can be reduced to 20% or so.

Accordingly, the flow channel grooves 10 on the separator substrate, the flow channel return portion 11 provided on the frame configuring a seal portion, and the projection 12 for preventing movement to an adjacent flow channel groove according to the present invention are used together to use communicated flow channels. Here, a larger number of the projections 12 are set on the fuel gas flow channel side than that on the oxidizer gas flow channel side so that an average gas flow rate will be increased by reducing the number of the flow channels running in parallel and the number of the flow channels running in parallel on the outlet side will be smaller than that on the inlet side by making the distance between the projections 12 on the fuel gas flow channel side on the outlet side in the cell narrower than that on the inlet side. It is thereby possible to set a total cross-sectional area of the flow channels running in parallel small. It is also possible to obtain the gas flow rate necessary to discharge the condensed water on the outlet side without making the flow rate on the inlet side excessive, even in the fuel gas flow channel of which supply flow rate is little and in which the rate of change of the gas flow rate is large in the flow channel. According to the present invention, it is possible to effectively prevent the condensed water from blocking up the reactive gas flow channel and lowering the performance of the fuel cell.

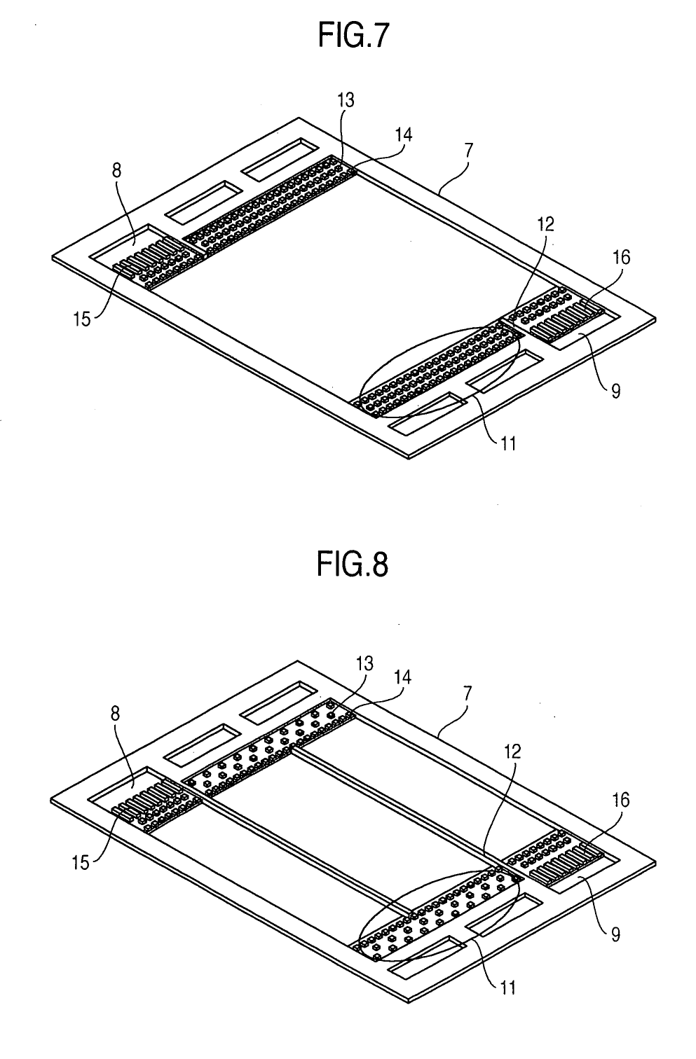

The projection 12 for preventing the reactive gas from moving to the adjacent flow channel groove is provided in order to prevent the reactive gas from bypass-leaking to the adjacent flow channel groove without passing the reactive gas flow channel 10 on the separator substrate via the flow channel return portion 11. A tip end operates as a rib forming the flow channel groove even if it extends flush with an inner edge of the frame as shown in FIG. 7. However, in order to prevent a bypass leak more securely, it should be projected inside the frame as shown in FIGS. 1, 3 and 5. Otherwise, the projections 12 may be extended over the entire length of the flow channel groove in the window of the opposed frame as shown in FIG. 8.

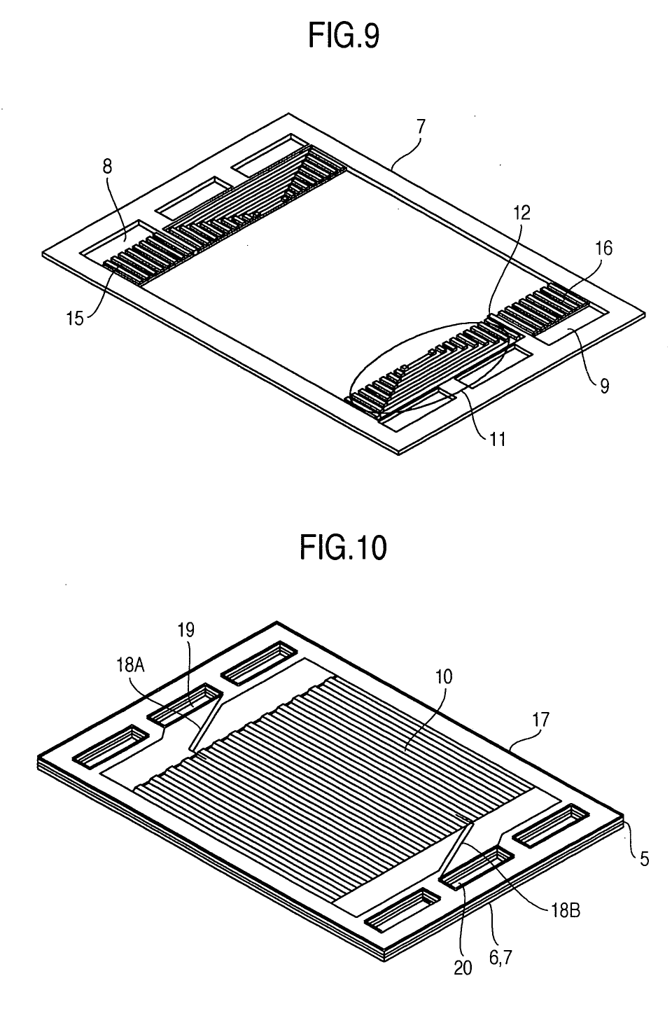

The flow channel return portion 11 may be a combination of vertical and horizontal flow channel grooves as shown in FIG. 9. In the case of setting the return portion at an arbitrary position by the projection 12, the flow channel return portion may be configured by the projections 13 as shown in FIGS. 3, 5 and 7. The projections 13 form the flow channel return portion 11 and also become strength members of the frame. A cell unit of the fuel cell applies clamp surface pressure to each part so that contact resistance becomes low and good cell performance is performed, and also, the surface pressure necessary for seal is applied thereby. From that viewpoint, among the projections of the flow channel return portion, the projections 14 on the inner edge of the frame may be reduced in distance therebetween, so that the effect of preventing reduction in strength can be obtained.

### Embodiment 2

FIG. 10 shows the structure of a cooling unit according to an embodiment of the fuel cell of the present invention. The flow channel grooves 10 provided on the separator substrate 5 shown in the first embodiment, and cooling unit flow channel guide portions 18A, 18B provided on a cooling unit frame 17 are incorporated to form the cooling unit flow channel. The coolant is supplied from an inlet manifold 19 of the cooling unit, is led to the flow channel grooves 10 on the separator substrate by the inlet side cooling unit flow channel guide portion 18A, and is reversed in flow direction by means of the outlet side cooling unit flow channel guide portion 18B so as to move back on the flow channel grooves of the separator substrate. Further, the flow direction is reversed by the inlet side cooling unit flow channel guide portion 18A, and it goes along the outlet side cooling unit flow channel guide portion 18B from the flow channel grooves 10 on the separator substrate to be discharged from a coolant outlet manifold 20. It is possible, by arbitrarily setting the number of flow channel guides provided at the inlet and outlet, to arbitrarily set the number of times of return of the cooling unit flow channel and to set the flow rate of the coolant. Therefore, in the case of assuming the fuel-cell cell stack to be a heat exchanger, it is possible to optimize the exchanging heat capacity depending on how to set the flow channel guide portions.

Thus, according to this embodiment, it is possible to give the same structure to all the separator substrates for supplying the gas and for supplying the coolant, and thereby form a desired structure of the cross-sectional area of the flow channel so as to efficiently discharge the accumulated water from the separator. Therefore, the manufacturing becomes easy and low-cost.

It should be further understood by those skilled in the art that although the foregoing description has been made on embodiments of the invention, the invention is not limited thereto and various changes and modifications may be made without departing from the spirit of the invention and the scope of the appended claims.

1. A fuel cell comprising a plurality of generating units layered, each of the generating unit including an electrolyte membrane electrode assembly, gas diffusion layers disposed so as to sandwich the electrolyte membrane electrode assembly therebetween, and a pair of separator units disposed outside the gas diffusion layers, wherein
the cross-sectional area of a downstream portion of a flow channel in a flow channel space formed between the separator unit and the gas diffusion layer is smaller than that of an upstream portion of the flow channel.

2. The fuel cell according to claim 1, wherein
the separator unit comprises a separator substrate having a plurality of flow channel grooves and a pair of frames disposed on both sides thereof;
a member for dividing the flow channel grooves into a required number of flow channel groove groups to change the cross-sectional area of the flow channel is provided in a window on a side on which the frame faces the gas diffusion layer; and
a return structure for changing a flow of fluid into a lateral direction with respect to a direction of the flow channel grooves is provided on a side on which the frame contacts the separator substrate.

3. The fuel cell according to claim 1, wherein one end of the return structure is communicated with a fluid inlet manifold, and the other end is communicated with a fluid outlet manifold.

4. The fuel cell according to claim 1, wherein said member is formed in said window of the pair of frames so as to extend in a central direction of the window and in a direction parallel with the flow channel grooves.

5. The fuel cell according to claim 1, wherein a downstream fluid speed in the generating unit is higher than an upstream fluid speed.

6. The fuel cell according to claim 2, wherein a flow direction of the fluid on an upstream side and the flow direction of the fluid on a downstream side of the flow channel grooves are changed once at least by said member and said return structure.

7. The fuel cell according to claim 1, wherein said members are formed at positions of an inlet portion and an outlet portion of the separator unit, at which positions the number of the flow channel grooves is different.

8. The fuel cell according to claim 1, wherein the closer to a fluid outlet manifold said members are, the smaller the pitch of the members is.

9. The fuel cell according to claim 1, wherein the pitch of a flow channel inlet portion opened on the manifold of a surface of said frame which surface contacts the separator substrate is equal to that of a flow channel groove portion provided on the separator substrate.

10. The fuel cell according to claim 1, wherein the member provided on one of the frames is formed over the entire length of the flow channel grooves in the frame.

11. The fuel cell according to claim 1, wherein the flow channel grooves of the separator substrate are formed by machining or press-working a metal plate.

12. A fuel cell comprising a plurality of generating units layered, each of the generating unit including an electrolyte membrane electrode assembly, gas diffusion layers disposed so as to sandwich the electrolyte membrane electrode assembly therebetween, a pair of gas separator units disposed outside the gas diffusion layers, and a cooling unit comprising a separator substrate and frames layered on both sides of the separator substrate, wherein
a member is disposed on the frames so that the cross-sectional area of a downstream portion of a flow channel in a flow channel space formed between the separator unit and the gas diffusion layer is smaller than that of an upstream portion of fluid.

13. The fuel cell according to claim 1, wherein the member provided on the frames of the gas separator unit is formed independently on front and rear surfaces of the separator substrate.

14. A fuel cell separator unit kit comprising a separator substrate with a plurality of flow channel grooves on both surfaces thereof, and frames contacting both of the surfaces of the separator substrate to form a space through which fluid flows, wherein
the frame has a window on one of the surfaces thereof; and
the window has at least one member for virtually dividing the flow channel grooves into a plurality of regions to change the cross-sectional area in a direction orthogonal to a flow direction of the flow channel grooves, and at least one return structure portion on the frame on the other surface for changing the flow of the fluid into a lateral direction.

15. The fuel cell separator unit kit according to claim 14, wherein the member is formed in a direction parallel to the flow channel grooves, in a flow channel space formed by the pair of frames and the separator substrate.

16. The fuel cell separator unit kit according to claim 14, wherein the member changes the flow directions of the fluid on an upstream side and a downstream side of the flow channel grooves, once at least.

17. A fuel cell generating unit kit comprising:
an electrolyte membrane electrode assembly having an electrolyte membrane and electrodes contacting both surfaces of the electrolyte membrane;
gas diffusion layers disposed on both surfaces of the electrolyte membrane electrode assembly; and
a pair of separator units disposed outside the gas diffusion layers, wherein
the separator unit has a separator substrate with a plurality of flow channel grooves on both surfaces thereof, and frames contacting both of the surfaces of the separator substrate to form a space through which fluid flows; and
at least one of the frames has one or more members for changing the cross-sectional area of the flow channels in a direction orthogonal to a flow direction.

18. The fuel cell separator unit kit according to claim 17, wherein the separator unit has the separator substrate with the plurality of flow channel grooves and a pair of frames disposed on both sides of the separator substrate, a window on a side on which the frames face the gas diffusion layers has a member for dividing the flow channel grooves into an arbitrary number of flow channel groove groups to change the cross-sectional area of the flow channel, and a return structure for changing a flow of fluid into a lateral direction with respect to a direction of the flow channel grooves are provided on a side on which the frames contact the separator substrate.

19. The fuel cell generating unit kit according to claim 17, wherein a flow direction of the fluid on an upstream side and the flow direction of the fluid on a downstream side of the flow channel grooves are changed once at least.

20. The fuel cell generating unit kit according to claim 17, wherein the separator units less than the number of the entire separator units are rendered as a cooling unit comprising the separator substrate and the frames layered on both sides of the separator substrate.
